(19) United States
(12) Patent Application Publication
(10) Pub. No.: US 2025/0321763 A1
(43) Pub. Date: Oct. 16, 2025

(54) INFORMATION PRESENTATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Yuxiang Wang, Beijing (CN); Qianwen Guo, Beijing (CN)

(21) Appl. No.: 19/088,824

(22) Filed: Mar. 24, 2025

(30) Foreign Application Priority Data
Apr. 12, 2024 (CN) 202410446236.1

(51) Int. Cl. G06F 9/451; G06Q 10/0631

(52) U.S. Cl. CPC G06F 9/451; G06Q 10/06311

(57) ABSTRACT

The present disclosure relates to an information presentation method and apparatus, an electronic device, and a storage medium. The method includes: presenting a details page in response to a details page presenting instruction for a parent object, the details page being used to present attribute information of the parent object; an attribute of the parent object including a schedule planning attribute; the details page including a schedule planning attribute presenting area of the parent object; in response to the parent object having a rollup relationship with a child object, presenting rollup prompt information in the schedule planning attribute presenting area; the rollup prompt information being used to prompt that the schedule planning attribute of the parent object involves rollup configuration; the child object being a subordinate object of the parent object.

### CROSS-REFERENCE TO RELATED APPLICATION(S)

This application claims priority to Chinese Application No. 202410446236.1 filed Apr. 12, 2024, the disclosure of which is incorporated herein by reference in its entity.

### FIELD

The present disclosure relates to the technical field of project management, and more particularly, to an information presentation method and apparatus, an electronic device, and a storage medium.

### BACKGROUND

With the rapid development of information technology, modern project management has been highly dependent on the application of various project management tools, which provide strong support for multi-user collaboration and greatly improve the efficiency of project execution and the ability of teams to work collaboratively. Through the project management tools, project division, definition of specific task objectives, and tracking of project progress can be performed.

However, in a complex project implementation process, there are often internal hierarchical relationships, such as parent-child relationships, between tasks. However, existing project management tools cannot manage tasks from the parent-child relationship perspective between tasks, resulting in problems in planning, monitoring, and adjusting project progress.

### SUMMARY

In order to solve the above technical problems or at least partially solve the above technical problems, the present disclosure provides an information presentation method and apparatus, an electronic device, and a storage medium.

In a first aspect, the present disclosure provides an information presentation method, including:
presenting a details page in response to a details page presenting instruction for a parent object, the details page being used to present attribute information of the parent object, an attribute of the parent object including a schedule planning attribute, and the details page including a schedule planning attribute presenting area of the parent object;
in response to the parent object having a rollup relationship with a child object, presenting rollup prompt information in the schedule planning attribute presenting area, the rollup prompt information being used to prompt that the schedule planning attribute of the parent object involves rollup configuration, the child object being a subordinate object of the parent object.

In a second aspect, the present disclosure further provides an information presentation apparatus, including:
a first presenting module, configured to present a details page in response to a details page presenting instruction for a parent object, the details page being used to present attribute information of the parent object; an attribute of the parent object including a schedule planning attribute; the details page including a schedule planning attribute presenting area of the parent object;
a second presenting module, configured to in response to the parent object having a rollup relationship with a child object, present rollup prompt information in the schedule planning attribute presenting area, the rollup prompt information being used to prompt that the schedule planning attribute of the parent object involves rollup configuration, the child object being a subordinate object of the parent object.

In a third aspect, the present disclosure further provides an electronic device, the electronic device including:
one or more processors;
a storage apparatus, configured to store one or more programs;
when the one or more programs are executed by the one or more processors, the one or more processors are caused to implement the information presentation method as described above.

In a fourth aspect, the present disclosure further provides a computer-readable storage medium having a computer program stored thereon, which, when executed by a processor, implements the information presentation method as described above.

### BRIEF DESCRIPTION OF THE DRAWINGS

The drawings herein are incorporated into and form a part of the specification, illustrate embodiments consistent with the present disclosure, and are used in conjunction with the specification to explain the principles of the present disclosure.

In order to more clearly illustrate the technical solutions in the embodiments of the present disclosure or in the prior art, the drawings to be used in the description of the embodiments or the prior art will be briefly introduced below. Obviously, for those of ordinary skill in the art, other drawings can be obtained from these drawings without paying any creative labor.

FIG. 1 is a flowchart of an information presentation method provided by an embodiment of the present disclosure;

FIG. 2 to FIG. 3 are schematic diagrams of several details pages provided by an embodiment of the present disclosure;

FIG. 4 is a flowchart of another information presentation method provided by an embodiment of the present disclosure;

FIG. 5 to FIG. 7 are schematic diagrams of several configuration pages provided by an embodiment of the present disclosure;

FIG. 8 is a flowchart of another information presentation method provided by an embodiment of the present disclosure;

FIG. 9 to FIG. 10 are schematic diagrams of another configuration page provided by an embodiment of the present disclosure;

FIG. 11 is a schematic diagram of another details page provided by an embodiment of the present disclosure;

FIG. 12 is a schematic structural diagram of an information presentation apparatus in an embodiment of the present disclosure; and

FIG. 13 is a schematic structural diagram of an electronic device in an embodiment of the present disclosure.

### DETAILED DESCRIPTION OF EMBODIMENTS

In order to understand the above objects, features, and advantages of the present disclosure more clearly, the solutions of the present disclosure will be further described below. It should be noted that the embodiments of the present disclosure and the features in the embodiments can be combined with each other without conflict.

Many specific details are set forth in the following description to facilitate a full understanding of the present disclosure, but the present disclosure may also be implemented in other ways different from those described herein. Obviously, the embodiments in the specification are only a part of the embodiments of the present disclosure, but not all of the embodiments.

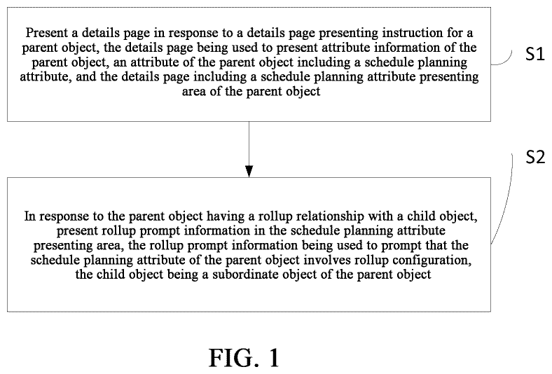

FIG. 1 is a flowchart of an information presentation method provided by an embodiment of the present disclosure. This embodiment is applicable to the case where a work item attribute in project management is configured in a client or a server. The method can be executed by an information presentation apparatus, and the apparatus can be implemented in software and/or hardware, and the apparatus can be configured in an electronic device. If the electronic device is a terminal, the electronic device specifically includes, but is not limited to, a smart phone, a palmtop computer, a tablet computer, a wearable device with a display screen, a desktop computer, a laptop, an all-in-one computer, a smart home device, etc.

As shown in FIG. 1, the method may specifically include the following.

S1, presenting a details page in response to a details page presenting instruction for a parent object, the details page being used to present attribute information of the parent object; an attribute of the parent object including a schedule planning attribute; the details page including a schedule planning attribute presenting area of the parent object.

In the present application, in the field of project management, an object generally refers to any work item that may be tracked, managed, assigned, and completed, which may be a specific work item such as an independent task, a requirement, a defect, a version, an iteration, or a milestone. Each object has its specific attributes, status, and lifecycle. A parent object is a work item or set of work, which is located at a higher level in terms of organizational structure, and may be further divided into several sub-tasks or sub-work items. A parent object generally represents a larger work unit or a phased objective, and its completion usually depends on the successful completion of its subordinate child objects. A child object may be, for example, a component of the parent object, which is subordinate to one or more parent objects, with a clear subordination relationship. A child object is a specific work task or phased result after the parent object is disassembled and refined, and its status change and completion directly affect the progress and completion of the parent object. A child object may be a small-granularity requirement decomposed from a requirement, a specific task disassembled from a project, or a sub-task within a certain iteration cycle.

Exemplarily, if a project is to develop a certain application, the project may be divided into a requirement analysis stage, a design stage, a development stage, a test stage, and a repair stage. The requirement analysis stage is to clarify the functions, target users, usage scenarios, etc. of the application. The work focus of the design stage is to perform interface design, architecture design, etc. The work focus of the development stage is to write code to implement functions. The work focus of the test stage is to perform various types of tests to ensure the quality of the application. The work focus of the repair stage is to solve problems found in the test. Further, the requirement analysis stage may be divided into a requirement collection stage, a requirement sorting stage, a requirement review stage, a requirement confirmation stage, and a requirement priority division stage. The work focus of the requirement collection stage is to acquire requirement information of users through various means. The work focus of the requirement sorting stage is to classify, sort, and summarize the collected requirements. The work focus of the requirement review stage is to review the accuracy and completeness of the requirements with related persons. The work focus of the requirement confirmation stage is to confirm requirements with users to ensure that both parties have a consistent understanding of the requirements. The work focus of the requirement priority division stage is to determine the priority of requirements so that development resources can be reasonably arranged.

Further, in the requirement analysis stage, requirement information collection needs to be performed first, and then a requirement specification manual is written. It is set that the requirement information collection is performed by a person C. It is set that the requirement specification manual needs to include three aspects: a detailed description of the requirement, a constraint condition, and a verification standard. Among them, a person A writes the detailed description of the requirement, and a person B writes the constraint condition and the verification standard.

In the above example, if the project of developing a certain application is taken as the parent object, the requirement analysis stage, the design stage, the development stage, the test stage, and the repair stage are all child objects. If the requirement analysis stage is taken as the parent object, the requirement collection stage, the requirement sorting stage, the requirement review stage, the requirement confirmation stage, and the requirement priority division stage each are child objects. If the requirement collection stage is taken as the parent object, the requirement information collection, the writing of the detailed description of the requirement, the writing of the constraint condition and the verification standard may be taken as child objects from the perspective of personnel arrangement. Alternatively, if the requirement collection stage is taken as the parent object, writing the requirement specification manual is taken as a whole, and at this time, the child objects are collecting requirement information and writing the requirement specification manual. Alternatively, if the requirement collection stage is taken as the parent object, since in the requirement analysis stage, the most concerned is the requirement specification manual, only the writing of the detailed description of the requirement, the writing of the constraint condition and the verification standard are taken as child objects.

The attribute of the parent object may be, for example, a feature or characteristic of the parent object, and attributes of different parent objects are at least partially different. Similarly, the attribute of the child object may be, for example, a feature or characteristic of the child object, and attributes of different child objects are at least partially different.

Exemplarily, if the parent object or the child object is a task, the attribute may include a task name, a description, a responsible person, a schedule plan, a priority, a project to which it belongs, and an association with other work items. If the parent object or the child object is a requirement, the attribute may include a requirement name, a source, a priority, a schedule plan, an association with other work items, and an acceptance standard.

In the present application, both the parent object and the child object have a schedule planning attribute. The schedule planning attribute may be, for example, a feature related to a schedule plan in the parent object or the child object. Exemplarily, the attribute of the schedule planning includes at least one of scheduling, estimated score, and actual man-hours. Scheduling may be, for example, arranging and planning the parent object or the child object in terms of time. The estimated score may be, for example, an estimated score or workload required to complete the parent object or the child object. The actual man-hours may be, for example, the working hours actually spent on completing the parent object or the child object.

The details page may be, for example, a page that presents attribute information of the parent object. The schedule planning attribute presenting area may be, for example, an area in the details page used to present the schedule planning attribute and related items of the parent object.

It should be noted that in the project management tool, for the same parent object, it has both a corresponding details page and a corresponding configuration page.

The details page is set to present and manage all attribute information of the parent object after the parent object is created, so as to facilitate the user to track, update, and communicate the execution process and results of the parent object. It usually includes, but is not limited to, basic information (such as a name, a description, a responsible person, a schedule plan, a priority, a project to which it belongs, and an association with other work items) set during configuration, and also includes dynamic content such as an execution progress, a real-time status, a history, an attachment, a discussion, a comment, and a list of child objects of the parent object. Usually, the details page may be directly opened by clicking a link or a name in a parent object list; or the details page may be opened by clicking a node of a parent object type in a workflow; or a details page of a certain parent object may be quickly located through searching or a navigation menu.

The configuration page is set to create, plan, and perform initial settings for a work item. On the configuration page, the user may define basic attributes, parameters, rules, and associated information of the parent object, such as setting a name, a description, a responsible person, a schedule plan, a priority, a project to which it belongs, and an association with other work items of the parent object. The configuration page is more used to plan and initialize the work item. Usually, the configuration page may be automatically opened when a new parent object is created, or the configuration page may be opened after clicking options such as “edit” or “set” in the details page of the parent object, so as to make necessary modifications or supplements.

All in all, the configuration page is an entry for creating and setting attributes of the parent object, while the details page is like an all-round control center for presenting and managing an overall picture of the parent object and its evolution process in the entire project lifecycle.

The details page presenting instruction for the parent object may be, for example, an instruction expressing that the user expects to open the details page of the parent object. In practice, optionally, the details page presenting instruction for the parent object is generated in response to a click operation on a link or a name in the parent object list; or the details page presenting instruction for the parent object is generated in response to a selection operation on a node of the parent object type in the workflow.

S2, in response to the parent object having a rollup relationship with a child object, presenting rollup prompt information in the schedule planning attribute presenting area; the rollup prompt information being used to prompt that the schedule planning attribute of the parent object involves rollup configuration; the child object being a subordinate object of the parent object.

The child object being a subordinate object of the parent object may mean, for example, that the child object is a result of disassembling the parent object. The child object has an association relationship with the parent object.

The parent object having a rollup relationship with the child object may mean, for example, that rollup results of schedule planning attributes of which child objects are configured to roll up to the parent object, so that the rollup results are associated with the schedule planning attribute of the parent object.

It should be noted that in practice, if the parent object is disassembled into M child objects, that is, the parent object corresponds to the M child objects. However, in practice, it can be set that the parent object has a rollup relationship with only some of the child objects, or it can be set that the parent object has a rollup relationship with all of the child objects. That is, it can be set that the number of child objects having a rollup relationship with the parent object is less than or equal to M, where M is a positive integer.

In the above technical solutions, in response to the parent object having a rollup relationship with the child object, the rollup prompt information is presented in the schedule planning attribute presenting area; the rollup prompt information is used to prompt that the schedule planning attribute of the parent object involves rollup configuration; the child object is a subordinate object of the parent object. Essentially, a function of rolling up schedule planning attributes of child objects to a parent object can be added to a project management tool, and the user can be prompted by means of rollup prompt information. This function can be managed from a parent-child relationship perspective between objects to assess an overall completion progress of the entire parent object, thereby avoiding the occurrence of poor conditions where problems occur in planning, monitoring, and adjusting project progress.

Further, the method may further include: presenting rollup details prompt information in response to a trigger operation on the rollup prompt information, the rollup details prompt information being used to prompt a child object having the rollup relationship with the parent object and/or a rollup result.

The trigger operation on the rollup prompt information may be, for example, an operation expressing a desire to know which child objects have a rollup relationship with the parent object and/or a rollup result. Exemplarily, the trigger operation on the rollup prompt information may include a click operation, a hover operation, a gesture operation, or a slide operation on the rollup prompt information.

In practice, optionally, the rollup details prompt information is used to prompt a child object having the rollup relationship with the parent object, the rollup result, and a rollup rule. The rollup rule may be, for example, a method or rule used to describe how to roll up schedule planning attribute information of the child object.

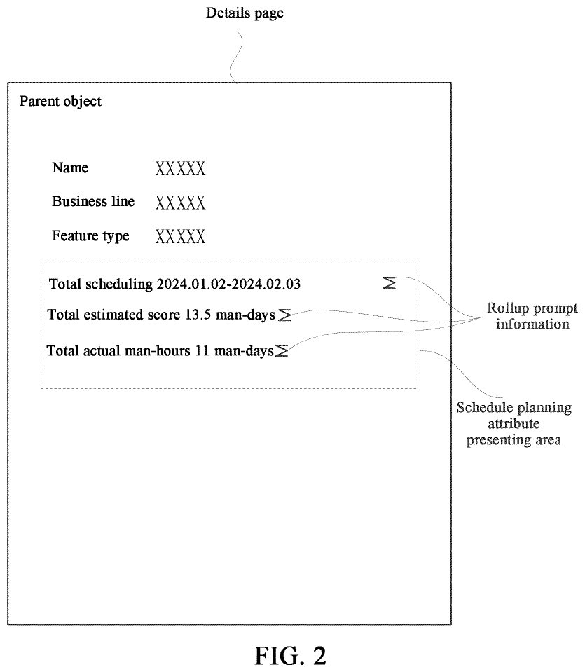

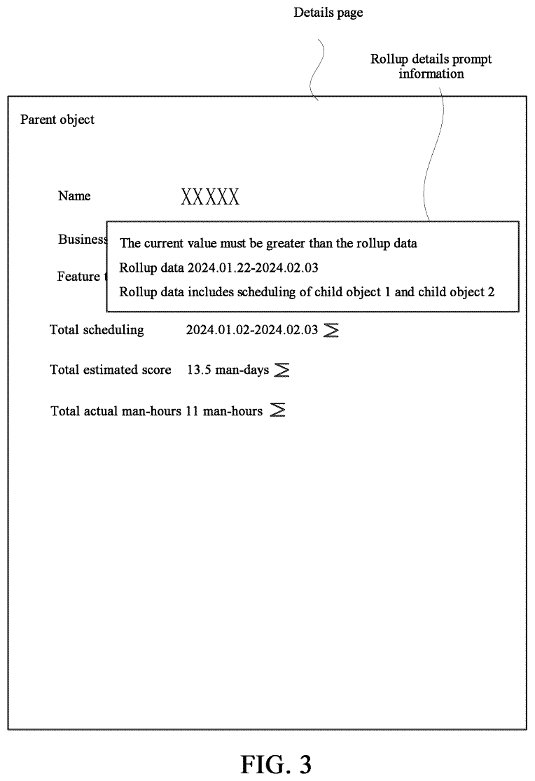

Exemplarily, referring to FIG. 2, the details page presents a name, a business line, a feature type, and a schedule planning attribute of the parent object. The presentation position of the schedule planning attribute is located in the schedule planning attribute presenting area. The schedule planning attribute includes total scheduling, total estimated score, and total actual man-hours. “Σ” in FIG. 2 is rollup prompt information. If the user clicks the rollup prompt information, referring to FIG. 3, the rollup details prompt information is presented in the form of a pop-up window. The rollup details prompt information includes three parts: a rollup rule, a rollup result, and a child object having a rollup relationship with the parent object. Among them, “the current value must be greater than the rollup data” is the rollup rule, “rollup data 2024.01.22-2024.02.03” is the rollup result, and “the rollup data includes scheduling of child object 1 and child object 2” is the child object having a rollup relationship with the parent object.

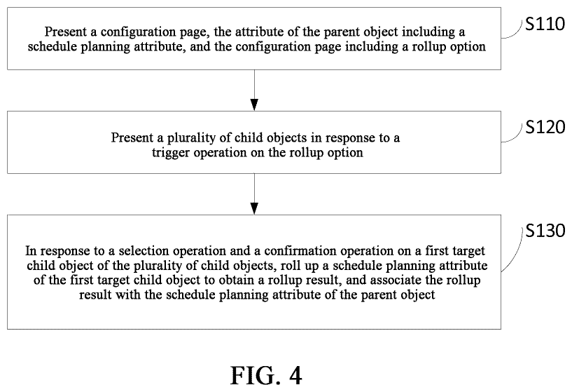

On the basis of the above technical solutions, optionally, before S1, referring to FIG. 4, the method further includes the following.

S110, presenting a configuration page, the attribute of the parent object including a schedule planning attribute; the configuration page including a rollup option.

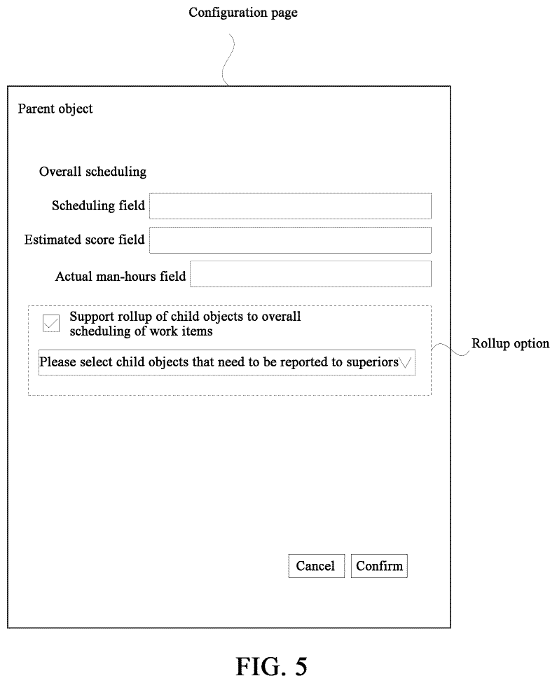

The rollup option may be, for example, an option used to configure a rollup relationship. Exemplarily, referring to FIG. 5, in the configuration page, the rollup option is composed of a radio box and an input box. The name of the radio box is “Support rollup of child objects to overall scheduling of work items”. The input box is preset with filling prompt information. The filling prompt information is “Please select child objects that need to be reported to superiors”.

S120, presenting a plurality of child objects in response to a trigger operation on the rollup option.

The trigger operation on the rollup option may be, for example, an operation expressing a desire to roll up schedule planning attribute information of child objects corresponding to the parent object. It may be specifically a click operation, a hover operation, a gesture operation, or a slide operation on the rollup option.

It should be emphasized that the child objects presented in this step are disassembled results obtained by disassembling the parent object mentioned in S110. The two have a superior-subordinate relationship.

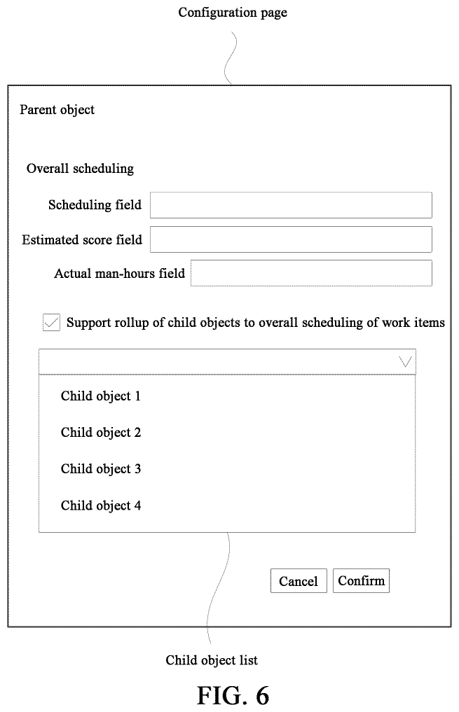

Exemplarily, continuing to refer to FIG. 5, when the radio box is in an unselected state, the input box is in an unfillable state. If the radio box is in a selected state, when the user clicks the input box, referring to FIG. 6, a child object list is presented. The child object list includes a plurality of child objects.

S130, in response to a selection operation and a confirmation operation on a first target child object of the plurality of child objects, rolling up a schedule planning attribute of the first target child object to obtain a rollup result, and associating the rollup result with the schedule planning attribute of the parent object.

The first target child object may be, for example, an object as a rollup basis. In practice, the user may select one or more child objects from the plurality of child objects, so that the selected child object is switched from an unselected state to a selected state, and then the user performs a confirmation operation on the selected child object, indicating that the user expects to take the currently selected child object as the first target child object.

The selection operation on the first target child object may be, for example, a click operation, a hover operation, a gesture operation, or a slide operation on one or more child objects of the plurality of child objects.

The confirmation operation on the first target child object may include, for example, a click operation, a hover operation, or a gesture operation on options such as a “confirm” option and an “apply” option in the configuration page.

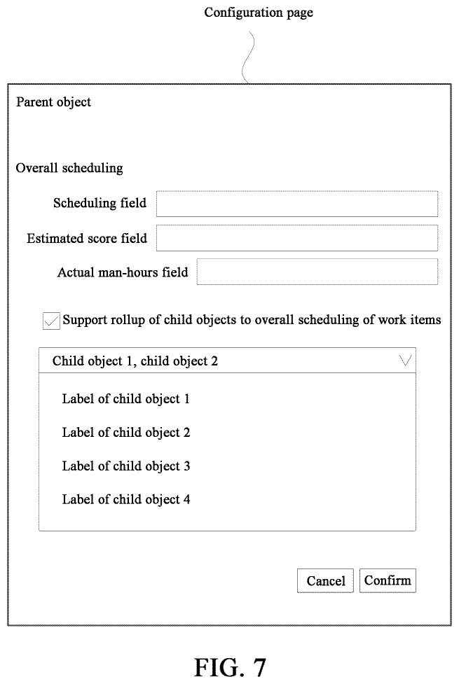

Exemplarily, continuing to refer to FIG. 6, if the user clicks child object 1 and child object 2 in the child object list, referring to FIG. 7, child object 1 and child object 2 are filled in the input box. At this time, child object 1 and child object 2 are in a selected state. Next, if the user clicks the “confirm” option in FIG. 7, child object 1 and child object 2 are taken as the first target child objects. The parent object has a rollup relationship with child object 1 and child object 2.

Since the first target child object has its own schedule planning attribute, rolling up the schedule planning attribute of the first target child object may be, for example, determining, based on the schedule planning attribute of the first target child object, an overall piece of information that can reflect a schedule planning status of the parent object. This information is the rollup result.

Associating the rollup result with the schedule planning attribute of the parent object may be, for example, taking the rollup result as content of the schedule planning attribute of the parent object.

In the above technical solutions, a configuration page is presented, the configuration page being used to configure an attribute of the parent object; the configuration page including a rollup option; a plurality of child objects are presented in response to a trigger operation on the rollup option; in response to a selection operation and a confirmation operation on a first target child object of the plurality of child objects, a schedule planning attribute of the first target child object is rolled up to obtain a rollup result, and the rollup result is associated with the schedule planning attribute of the parent object. Essentially, a function of rolling up schedule planning attributes of child objects and taking the rollup result obtained by rolling up as the schedule planning attribute of the parent object can be added to a project management tool. This function can be managed from a parent-child relationship perspective between objects to assess an overall completion progress of the entire parent object, thereby avoiding the occurrence of poor conditions where problems occur in planning, monitoring, and adjusting project progress.

Further, the method further includes: obtaining second schedule planning information of the schedule planning attribute of the parent object; determining first schedule planning information of the parent object based on the second schedule planning information and the rollup result; and presenting the first schedule planning information in the schedule planning attribute presenting area of the details page.

The second schedule planning information may be, for example, a schedule plan set by the user for the parent object as required. The rollup result is a schedule plan calculated by the electronic device according to the established rollup relationship. In practice, the second schedule planning information and the rollup result may have an overlapping part, or may not have an overlapping part.

Optionally, determining the first schedule planning information of the parent object based on the second schedule planning information and the rollup result includes: determining the first schedule planning information of the parent object based on a range indicated by the second schedule planning information and a range indicated by the rollup result; the range indicated by the first schedule planning information being greater than or equal to the range indicated by the rollup result. Further, it can be set that the range indicated by the first schedule planning information is greater than or equal to the range indicated by the second schedule planning information.

When the schedule planning information is information in terms of a time span (such as information of 2024.01.02-2024.01.04, etc.), the range indicated by the schedule planning information may be, for example, a time period implemented on a calendar. When the schedule planning information is information describing workload (such as information of 3 man-days, etc.), the range indicated by the schedule planning information may be, for example, a total amount of work, that is, a total number of man-days.

Since the rollup result is essentially the schedule planning information, the range indicated by the rollup result has the same meaning as the range indicated by the schedule planning information.

Exemplarily, if the range indicated by the second schedule planning information is regarded as a set A, and the range indicated by the rollup result is regarded as a set B, the process of determining the first schedule planning information of the parent object may be understood as a process of taking a union of the set A and the set B.

Taking scheduling as an example, in one example, the second schedule planning information of a certain parent object is 2024.01.02-2024.02.03, and the rollup result is 2024.01.22-2024.02.03. In this case, there is an overlapping part between the two, which is 2024.01.22-2024.02.03. It can be set that the first schedule planning information is the same as the second schedule planning information, both of which are 2024.01.02-2024.02.03.

In another example, the second schedule planning information of a certain parent object is 2024.01.02-2024.01.04, and the rollup result is 2024.01.01-2024.01.02. In this case, there is an overlapping part between the two, which is 2024.01.02. It can be set that the first schedule planning information is 2024.01.01-2024.01.04. The range indicated by the first schedule planning information is greater than the range indicated by the second schedule planning information and also greater than the range indicated by the rollup result.

Taking estimated score as an example, in one example, the second schedule planning information of a certain parent object is 3 man-days, and the rollup result is 2.5 man-days. In this case, it can be set that the first schedule planning information is the same as the second schedule planning information, both of which are 3 man-days.

In another example, the second schedule planning information of a certain parent object is 3 man-days, and the rollup result is 3.5 man-days. In this case, it can be set that the first schedule planning information is the same as the rollup result, both of which are 3.5 man-days.

In practice, only the first schedule planning information may be presented in the schedule planning attribute presenting area of the details page, or only the second schedule planning information may be presented in the schedule planning attribute presenting area of the details page, or both the first schedule planning information and the second schedule planning information may be presented in the schedule planning attribute presenting area of the details page.

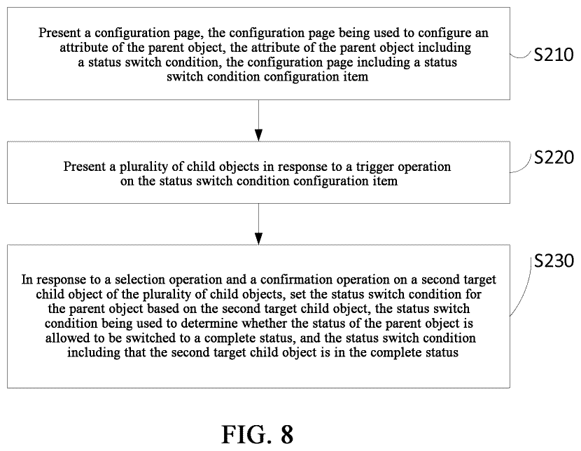

On the basis of the above technical solutions, optionally, referring to FIG. 8, the method further includes the following.

S210, presenting a configuration page, the configuration page being used to configure an attribute of the parent object; the attribute of the parent object including a status switch condition, the configuration page including a status switch condition configuration item.

The status switch condition may be, for example, a precondition or prerequisite that must be satisfied before the status of the parent object is switched to the complete status. Exemplarily, if the status switch condition of the parent object is condition 1, it means that in the case where the condition 1 is satisfied, the status of the parent object is allowed to be switched to the complete status. In other words, if the condition 1 is not satisfied, the status of the parent object is restricted to switch to the complete status.

The status switch condition configuration item may be, for example, an option for configuring the status switch condition for the parent object.

S220, presenting a plurality of child objects in response to a trigger operation on the status switch condition configuration item.

The trigger operation on the status switch condition configuration item may be, for example, an operation expressing a desire to configure the status switch condition for the parent object. Exemplarily, the trigger operation on the status switch condition configuration item may include a click operation, a hover operation, a gesture operation, or a slide operation on the status switch condition configuration item.

It should be emphasized that the child objects presented in this step are disassembled results obtained by disassembling the parent object mentioned in S210.

S230, in response to a selection operation and a confirmation operation on a second target child object of the plurality of child objects, setting the status switch condition for the parent object based on the second target child object, the status switch condition being used to determine whether the status of the parent object is allowed to be switched to a complete status, and the status switch condition including that the second target child object is in the complete status.

The second target child object is a factor that affects whether the parent object can be switched to the complete status. In practice, the user may select one or more child objects from the plurality of child objects, so that the selected child object is switched from an unselected state to a selected state, and then the user performs a confirmation operation on the selected child object, indicating that the user expects to take the currently selected child object as the second target child object.

The selection operation on the second target child object may be, for example, a click operation, a hover operation, a gesture operation, or a slide operation on two or more child objects of the plurality of child objects.

The confirmation operation on the second target child object may include, for example, a click operation, a hover operation, or a gesture operation on options such as a “confirm” option and an “apply” option in the configuration page.

It should be noted here that in practice, if a set composed of all child objects corresponding to the parent object is taken as a complete set, a set composed of all first target child objects is taken as a first set, and a set composed of all second target child objects is taken as a second set, the first set and the second set are both subsets of the complete set, and the first set and the second set may include the same elements or different elements.

The status switch condition including that the second target child object is in the complete status means that in the case where the second target child object is in the complete status, the status of the parent object is allowed to be switched to the complete status.

Further, it can be set that in the case where the second target child object is in the complete status, the status of the parent object is automatically switched to the complete status; or it can be set that in the case where the second target child object is in the complete status, the status of the parent object is switched to the complete status in response to a status switch operation for the parent object. The status switch operation for the parent object may be, for example, an operation expressing a desire to switch the status of the parent object to the complete status. In other words, in the case where the second target child object is in the complete status, the status of the parent object may be automatically adjusted, or the status of the parent object may be manually adjusted by the user.

It should be noted that in practice, if the parent object is disassembled into M child objects, the number of the second target child objects in this step may be less than or equal to M, where M is a positive integer.

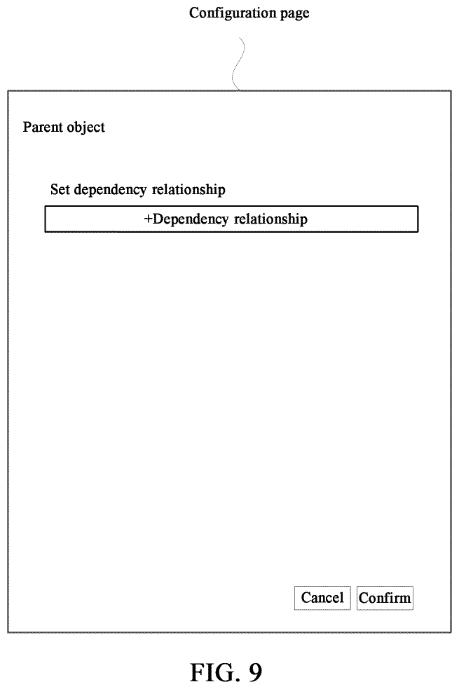

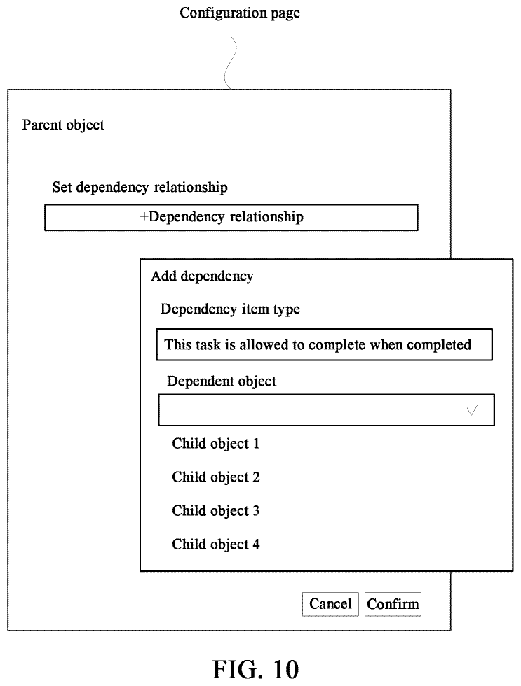

Exemplarily, referring to FIG. 9, a “+dependency relationship” option in the configuration page is the status switch condition configuration item. When the user clicks the “+dependency relationship” option, referring to FIG. 10, four child objects are presented in the form of a pop-up window. Assuming that the user selects child object 1, child object 2, and child object 3, “child object 1, child object 2, and child object 3” will be filled in the input box under “dependency object”. Subsequently, if the user clicks the “confirm” option in FIG. 10, child object 1, child object 2, and child object 3 are taken as second target child objects. Furthermore, for the parent object, it is set that the status switch condition includes that when the statuses of child object 1, child object 2, and child object 3 are all in the complete status, the status of the parent object can be switched to the complete status.

In the above technical solutions, a configuration page is presented, the configuration page being used to configure an attribute of the parent object; the attribute of the parent object including a status switch condition, the configuration page including a status switch condition configuration item;
a plurality of child objects are presented in response to a trigger operation on the status switch condition configuration item;
in response to a selection operation and a confirmation operation on a second target child object of the plurality of child objects, the status switch condition is set for the parent object based on the second target child object, the status switch condition being used to determine whether the status of the parent object is allowed to be switched to a complete status, and the status switch condition including that the second target child object is in the complete status. Essentially, the status switch of the parent object is associated with the status switch of the second target child object. In this way, the status can be managed from the parent-child relationship perspective between objects, ensuring that there will be no contradictory situation where a child object is still in an intermediate state (such as “in progress” state) while its parent object is marked as a completed state.

Optionally, presenting a details page in response to a details page presenting instruction for a parent object includes: obtaining a status switch condition of the parent object in response to the details page presenting instruction for the parent object; determining a second target child object from child objects corresponding to the parent object based on the status switch condition of the parent object; presenting the details page, the details page including a child object presenting area, the child object presenting area presenting identification information of a plurality of the child objects and condition prompt information; the condition prompt information corresponding to the second target child object, the condition prompt information being used to prompt that the status of the parent object is allowed to be switched to the complete status after the status of the second target child object corresponding thereto is switched to the complete status. The second target child object is a child object specified in the process of configuring the status switch condition.

The child object presentation area may be, for example, an area in the details page used to present related information of the child object.

The identification information of the child object may be, for example, information used to distinguish one child object from other child objects. If all attribute information of a child object is regarded as a complete set, the identification information of the child object is a subset of the complete set. Exemplarily, the identification information of the child object may include at least one of the following: a name and a participant of the child object, schedule planning information, and a status.

The condition prompt information may be represented in the form of text and/or symbols.

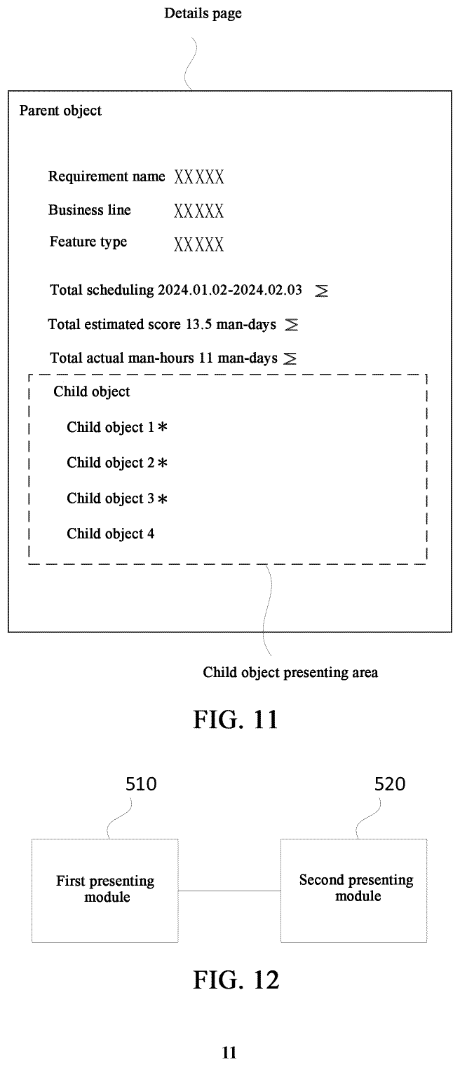

Exemplarily, referring to FIG. 11, after the details page presenting instruction for the parent object is acquired, the status switch condition of the parent object is acquired. If the status switch condition of the parent object includes that when the statuses of child object 1, child object 2, and child object 3 are all in the complete status, the status of the parent object can be switched to the complete status. Based on this, it is determined that child object 1, child object 2, and child object 3 are the second target child objects, and the details page is presented. The identification information of four child objects is presented in the child object presenting area in the details page, where the upper right corners of child object 1, child object 2, and child object 3 all have a mark of “*”, and the mark is the condition prompt information.

By setting that the identification information of a plurality of child objects and the condition prompt information are presented in the child object presenting area; the condition prompt information corresponding to the second target child object, the condition prompt information being used to prompt that the status of the parent object is allowed to be switched to the complete status after the status of the second target child object corresponding thereto switches to the complete status; on the one hand, the user can quickly understand which child objects the parent object is disassembled into, and on the other hand, the user can quickly understand which child objects are allowed to be switched the status of the parent object to the complete status after being in the complete status.

It should be understood that before using the technical solutions disclosed in the embodiments of the present disclosure, the user should be informed of the type, scope of use, usage scenario, etc. of the personal information involved in the present disclosure in an appropriate manner in accordance with relevant laws and regulations, and the authorization of the user should be obtained.

For example, in response to receiving an active request from a user, prompt information is sent to the user, so as to explicitly prompt the user that the operation requested by him/her to perform will require the acquisition and use of the user's personal information. Thus, the user can independently choose whether to provide the personal information to the software or hardware, such as an electronic device, an application, a server, or a storage medium, that performs the operations of the technical solutions of the present disclosure, according to the prompt information.

As an optional but non-limiting implementation, the manner of sending prompt information to the user in response to receiving the active request from the user may be, for example, in the form of a pop-up window, and the prompt information may be presented in text in the pop-up window. In addition, the pop-up window may also include a selection control for the user to select “agree” or “disagree” to provide the personal information to the electronic device.

It should be understood that the above process of notifying and acquiring user authorization is only illustrative, and does not limit the implementations of the present disclosure. Other manners that meet relevant laws and regulations may also be applied to the implementations of the present disclosure.

It should be noted that, for the above method embodiments, for the purpose of simple description, they are all expressed as a series of action combinations, but those skilled in the art should know that the present invention is not limited by the described order of actions, because according to the present invention, some steps may be performed in other orders or simultaneously. Secondly, those skilled in the art should also know that the embodiments described in the specification are all preferred embodiments, and the involved actions and modules are not necessarily necessary for the present invention.

FIG. 12 is a schematic structural diagram of an information presentation apparatus in an embodiment of the present disclosure. The information presentation apparatus provided by the embodiment of the present disclosure may be configured in a client or a server. Referring to FIG. 12, the information presentation apparatus specifically includes the following.

A first presenting module 510, configured to present a details page in response to a details page presenting instruction for a parent object, the details page being used to present attribute information of the parent object; an attribute of the parent object including a schedule planning attribute; the details page including a schedule planning attribute presenting area of the parent object;

A second presenting module 520, configured to present, in response to the parent object having arollup relationship with a child object, rollup prompt information in the schedule planning attribute presenting area; the rollup prompt information being used to prompt that the schedule planning attribute of the parent object involves rollup configuration; the child object being a subordinate object of the parent object.

Further, the apparatus further includes a third presenting module, configured to:
present rollup details prompt information in response to a trigger operation on the rollup prompt information, the rollup details prompt information being used to prompt a child object having the rollup relationship with the parent object and/or a rollup result.

Further, the apparatus further includes a first configuration page, configured to:
before presenting a details page in response to a details page presenting instruction for a parent object, present a configuration page, the configuration page being used to configure an attribute of the parent object; the configuration page including a rollup option;
present a plurality of child objects in response to a trigger operation on the rollup option;
in response to a selection operation and a confirmation operation on a first target child object of the plurality of child objects, roll up a schedule planning attribute of the first target child object to obtain a rollup result, and associate the rollup result with the schedule planning attribute of the parent object.

Further, the third presenting module is configured to:
obtain second schedule planning information of the schedule planning attribute of the parent object;
determine first schedule planning information of the parent object based on the second schedule planning information and the rollup result;
present the first schedule planning information in the schedule planning attribute presenting area of the details page.

Further, the third presenting module is configured to:
determine the first schedule planning information of the parent object based on a range indicated by the second schedule planning information and a range indicated by the rollup result; the range indicated by the first schedule planning information being greater than or equal to the range indicated by the rollup result.

Further, the apparatus further includes a second configuration module, configured to:
present a configuration page, the configuration page being used to configure an attribute of the parent object; the attribute of the parent object including a status switch condition, the configuration page including a status switch condition configuration item;
present a plurality of child objects in response to a trigger operation on the status switch condition configuration item;
in response to a selection operation and a confirmation operation on a second target child object of the plurality of child objects, set the status switch condition for the parent object based on the second target child object, the status switch condition being used to determine whether the status of the parent object is allowed to be switched to a complete status, and the status switch condition including that the second target child object is in the complete status.

Further, the first presenting module 510 is configured to:
obtain a status switch condition of the parent object in response to the details page presenting instruction for the parent object;
determine a second target child object from child objects corresponding to the parent object based on the status switch condition of the parent object;
present the details page, the details page including a child object presenting area, the child object presenting area presenting identification information of a plurality of the child objects and condition prompt information; the condition prompt information corresponding to the second target child object, the condition prompt information being used to prompt that the status of the parent object is allowed to be switched to the complete status after the status of the second target child object corresponding thereto is switched to the complete status.

The information presentation apparatus provided by the embodiment of the present disclosure may perform the steps performed by the client or the server in the information presentation method provided by the method embodiments of the present disclosure, and has the execution steps and beneficial effects, which will not be repeated here.

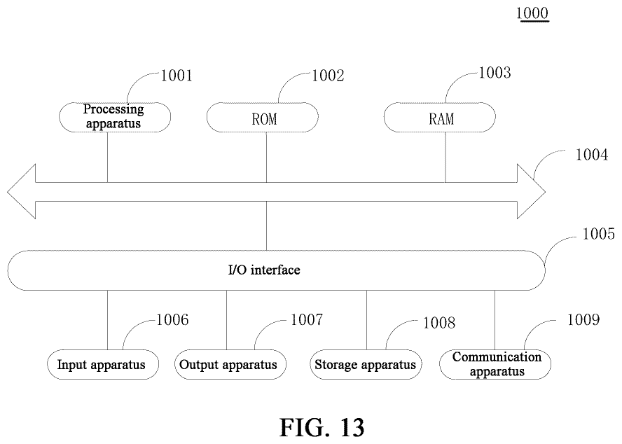

FIG. 13 is a schematic structural diagram of an electronic device in an embodiment of the present disclosure. Reference is made specifically to FIG. 13 below, which illustrates a schematic structural diagram of an electronic device 1000 suitable for implementing the embodiments of the present disclosure. The electronic device 1000 in the embodiment of the present disclosure may include, but is not limited to, mobile terminals such as a mobile phone, a laptop, a digital broadcast receiver, a PDA (personal digital assistant), a PAD (tablet computer), a PMP (portable multimedia player), a vehicle-mounted terminal (for example, a vehicle-mounted navigation terminal), a wearable electronic device, and fixed terminals such as a digital TV, a desktop computer, a smart home device, etc. The electronic device shown in FIG. 13 is only an example, and should not bring any limitation to the functions and scope of use of the embodiments of the present disclosure.

As shown in FIG. 13, the electronic device 1000 may include a processing apparatus (for example, a central processing unit, a graphics processing unit, etc.) 1001, which may perform various appropriate actions and processes according to a program stored in a read-only memory (ROM) 1002 or a program loaded from a storage apparatus 1008 into a random-access memory (RAM) 1003 to implement the information presentation method of the embodiments as described in the present disclosure. The RAM 1003 further stores various programs and information required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touchscreen, a touchpad, a keyboard, a mouse, a camera, a microphone, an accelerometer, a gyroscope, etc.; an output apparatus 1007 including, for example, a liquid crystal display (LCD), a speaker, a vibrator, etc.; the storage apparatus 1008 including, for example, a magnetic tape, a hard disk, etc.; and a communication apparatus 1009. The communication apparatus 1009 may allow the electronic device 1000 to perform wireless or wired communication with other devices to exchange information. While FIG. 13 shows the electronic device 1000 having various apparatuses, it should be understood that it is not required to implement or have all of the illustrated apparatuses. More or fewer apparatuses may alternatively be implemented or provided.

In particular, according to an embodiment of the present disclosure, the process described above with reference to the flowchart can be implemented as a computer software program. For example, the embodiment of the present disclosure includes a computer program product, which includes a computer program carried on a non-transitory computer-readable medium, and the computer program includes program codes for executing the method shown in the flowchart, thereby implementing the information presentation method as described above. In such an embodiment, the computer program may be downloaded and installed from the network through the communication apparatus 1009, or installed from the storage apparatus 1008, or installed from the ROM 1002. When the computer program is executed by the processing apparatus 1001, the above-mentioned functions defined in the method of the embodiment of the present disclosure are executed.

It should be noted that the above computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include an information signal propagated in a baseband or as a part of a carrier wave, in which a computer-readable program code is carried. The propagated information signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained on the computer-readable medium may be transmitted by any suitable medium, including but not limited to an electrical wire, an optical cable, RF (radio frequency), etc., or any suitable combination thereof.

In some embodiments, the client and the server may communicate using any known or future-developed network protocol such as HTTP (HyperText Transfer Protocol), and may be interconnected with digital information communication (for example, a communication network) in any form or medium. Examples of the communication network include local area networks (“LAN”), wide area networks (“WAN”), international networks (for example, the Internet), and end-to-end networks (for example, ad hoc end-to-end networks), as well as any known or future-developed networks.

The above computer-readable medium may be included in the above electronic device; or it may exist alone without being assembled into the electronic device.

The above computer-readable medium carries one or more programs, and when the one or more programs are executed by the electronic device, the electronic device is caused to:
present a details page in response to a details page presenting instruction for a parent object, the details page being used to present attribute information of the parent object; an attribute of the parent object including a schedule planning attribute; the details page including a schedule planning attribute presenting area of the parent object;
in response to the parent object having a rollup relationship with a child object, present rollup prompt information in the schedule planning attribute presenting area; the rollup prompt information being used to prompt that the schedule planning attribute of the parent object involves rollup configuration; the child object being a subordinate object of the parent object.

Optionally, when the one or more programs are executed by the electronic device, the electronic device may also perform other steps described in the above embodiments.

The computer program codes for performing the operations of the present disclosure may be written in one or more programming languages or a combination thereof. The above programming languages include object-oriented programming languages such as Java, Smalltalk, C++, and also include conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the case involving the remote computer, the remote computer may be connected to the user's computer through any kind of network, including a local area network (LAN) or a wide area network (WAN), or may be connected to an external computer (for example, via the Internet through an Internet service provider).

The flowcharts and block diagrams in the drawings illustrate the architecture, functions, and operations of possible implementations of systems, methods, and computer program products according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions marked in the blocks may also occur in a different order than those marked in the drawings. For example, two blocks shown in succession may actually be executed substantially in parallel, or they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The units involved in the embodiments of the present disclosure may be implemented in software or hardware. The name of a unit does not constitute a limitation on the unit itself under certain circumstances.

The functions described above herein can be performed at least in part by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, the present disclosure provides an electronic device, including:
one or more processors;
a memory, configured to store one or more programs;
when the one or more programs are executed by the one or more processors, the one or more processors are caused to implement any one of the information presentation methods provided by the present disclosure.

According to one or more embodiments of the present disclosure, the present disclosure provides a computer-readable storage medium having a computer program stored thereon, which, when executed by a processor, implements any one of the information presentation methods provided by the present disclosure.

An embodiment of the present disclosure further provides a computer program product, which includes a computer program or instruction, and when the computer program or instruction is executed by a processor, the information presentation method as described above is implemented.

It should be noted that in this specification, relational terms such as “first” and “second” are only used to distinguish one entity or operation from another entity or operation, and do not necessarily require or imply any such actual relationship or order between these entities or operations. Moreover, the term “include/include” or any other variant thereof is intended to cover non-exclusive inclusion, so that a process, method, article, or device including a series of elements includes not only those elements but also other elements not expressly listed, or elements inherent to such process, method, article, or device. Without further limitation, an element defined by the phrase “include/include one . . . ” does not exclude the presence of additional identical elements in the process, method, article, or device that includes the element.

The above are only specific implementations of the present disclosure, which enable those skilled in the art to understand or implement the present disclosure. Various modifications to these embodiments will be obvious to those skilled in the art, and the general principles defined herein can be implemented in other embodiments without departing from the spirit or scope of the present disclosure. Therefore, the present disclosure will not be limited to these embodiments described herein, but will conform to the widest scope consistent with the principles and novel features disclosed herein.

I/We claim:

1. An information presentation method, comprising:
presenting a details page in response to a details page presenting instruction for a parent object, the details page being used to present attribute information of the parent object, an attribute of the parent object comprising a schedule planning attribute, and the details page comprising a schedule planning attribute presenting area of the parent object; and
in response to the parent object having a rollup relationship with a child object, presenting rollup prompt information in the schedule planning attribute presenting area, the rollup prompt information being used to prompt that the schedule planning attribute of the parent object involves rollup configuration, the child object being a subordinate object of the parent object.

2. The method according to claim 1, further comprising:
presenting rollup details prompt information in response to a trigger operation on the rollup prompt information, the rollup details prompt information being used to prompt a child object having the rollup relationship with the parent object and/or a rollup result.

3. The method according to claim 1, further comprising: before presenting the details page in response to the details page presenting instruction for the parent object,
presenting a configuration page, the configuration page being used to configure an attribute of the parent object, and the configuration page comprising a rollup option;
presenting a plurality of child objects in response to a trigger operation on the rollup option; and
in response to a selection operation and a confirmation operation on a first target child object of the plurality of child objects, rolling up a schedule planning attribute of the first target child object to obtain a rollup result, and associating the rollup result with the schedule planning attribute of the parent object.

4. The method according to claim 2, further comprising:
obtaining second schedule planning information of the schedule planning attribute of the parent object;
determining first schedule planning information of the parent object based on the second schedule planning information and the rollup result; and
presenting the first schedule planning information in the schedule planning attribute presenting area of the details page.

5. The method according to claim 4, wherein determining the first schedule planning information of the parent object based on the second schedule planning information and the rollup result comprises:
determining the first schedule planning information of the parent object based on a range indicated by the second schedule planning information and a range indicated by the rollup result, the range indicated by the first schedule planning information being greater than or equal to the range indicated by the rollup result.

6. The method according to claim 1, further comprising:
presenting a configuration page, the configuration page being used to configure an attribute of the parent object, the attribute of the parent object comprising a status switch condition, the configuration page comprising a status switch condition configuration item;
presenting a plurality of child objects in response to a trigger operation on the status switch condition configuration item; and
in response to a selection operation and a confirmation operation on a second target child object of the plurality of child objects, setting the status switch condition for the parent object based on the second target child object, the status switch condition being used to determine whether a status of the parent object is allowed to be switched to a complete status, and the status switch condition comprising that the second target child object is in the complete status.

7. The method according to claim 1, wherein presenting the details page in response to the details page presenting instruction for the parent object comprises:
obtaining a status switch condition of the parent object in response to the details page presenting instruction for the parent object;
determining a second target child object from child objects corresponding to the parent object based on the status switch condition of the parent object; and
presenting the details page, the details page comprising a child object presenting area, the child object presenting area presenting identification information of a plurality of child objects and condition prompt information, the condition prompt information corresponding to the second target child object, the condition prompt information being used to prompt that a status of the parent object is allowed to be switched to the complete status after a status of the second target child object corresponding thereto is switched to the complete status.

8. An electronic device, comprising:
one or more processors; and
a storage, configured to store one or more programs,
wherein when the one or more programs are executed by the one or more processors, the one or more processors are caused to:
present a details page in response to a details page presenting instruction for a parent object, the details page being used to present attribute information of the parent object, an attribute of the parent object comprising a schedule planning attribute, and the details page comprising a schedule planning attribute presenting area of the parent object; and
in response to the parent object having a rollup relationship with a child object, present rollup prompt information in the schedule planning attribute presenting area, the rollup prompt information being used to prompt that the schedule planning attribute of the parent object involves rollup configuration, the child object being a subordinate object of the parent object.

9. The electronic device according to claim 8, wherein the one or more processors are further caused to:
present rollup details prompt information in response to a trigger operation on the rollup prompt information, the rollup details prompt information being used to prompt a child object having the rollup relationship with the parent object and/or a rollup result.

10. The electronic device according to claim 8, wherein the one or more processors are further caused to:
before presenting the details page in response to the details page presenting instruction for the parent object, present a configuration page, the configuration page being used to configure an attribute of the parent object, and the configuration page comprising a rollup option;
present a plurality of child objects in response to a trigger operation on the rollup option; and
in response to a selection operation and a confirmation operation on a first target child object of the plurality of child objects, roll up a schedule planning attribute of the first target child object to obtain a rollup result, and associate the rollup result with the schedule planning attribute of the parent object.

11. The electronic device according to claim 9, wherein the one or more processors are further caused to:
obtain second schedule planning information of the schedule planning attribute of the parent object;
determine first schedule planning information of the parent object based on the second schedule planning information and the rollup result; and
present the first schedule planning information in the schedule planning attribute presenting area of the details page.

12. The electronic device according to claim 11, wherein the one or more processors are caused to determine the first schedule planning information of the parent object based on the second schedule planning information and the rollup result by being caused to:
determine the first schedule planning information of the parent object based on a range indicated by the second schedule planning information and a range indicated by the rollup result, the range indicated by the first schedule planning information being greater than or equal to the range indicated by the rollup result.

13. The electronic device according to claim 8, wherein the one or more processors are further caused to:
present a configuration page, the configuration page being used to configure an attribute of the parent object, the attribute of the parent object comprising a status switch condition, the configuration page comprising a status switch condition configuration item;
present a plurality of child objects in response to a trigger operation on the status switch condition configuration item; and
in response to a selection operation and a confirmation operation on a second target child object of the plurality of child objects, set the status switch condition for the parent object based on the second target child object, the status switch condition being used to determine whether a status of the parent object is allowed to be switched to a complete status, and the status switch condition comprising that the second target child object is in the complete status.

14. The electronic device according to claim 8, wherein the one or more processors are caused to present the details page in response to the details page presenting instruction for the parent object by being caused to:
obtain a status switch condition of the parent object in response to the details page presenting instruction for the parent object;
determine a second target child object from child objects corresponding to the parent object based on the status switch condition of the parent object; and
present the details page, the details page comprising a child object presenting area, the child object presenting area presenting identification information of a plurality of child objects and condition prompt information, the condition prompt information corresponding to the second target child object, the condition prompt information being used to prompt that a status of the parent object is allowed to be switched to the complete status after a status of the second target child object corresponding thereto is switched to the complete status.

15. A non-transitory computer-readable storage medium, storing a computer program thereon, wherein the program, when executed by a processor, implements:
presenting a details page in response to a details page presenting instruction for a parent object, the details page being used to present attribute information of the parent object, an attribute of the parent object comprising a schedule planning attribute, and the details page comprising a schedule planning attribute presenting area of the parent object; and
in response to the parent object having a rollup relationship with a child object, presenting rollup prompt information in the schedule planning attribute presenting area, the rollup prompt information being used to prompt that the schedule planning attribute of the parent object involves rollup configuration, the child object being a subordinate object of the parent object.

16. The non-transitory computer-readable storage medium according to claim 15, wherein the program further implements:
presenting rollup details prompt information in response to a trigger operation on the rollup prompt information, the rollup details prompt information being used to prompt a child object having the rollup relationship with the parent object and/or a rollup result.

17. The non-transitory computer-readable storage medium according to claim 15, wherein the program further implements: before presenting the details page in response to the details page presenting instruction for the parent object,
presenting a configuration page, the configuration page being used to configure an attribute of the parent object, and the configuration page comprising a rollup option;
presenting a plurality of child objects in response to a trigger operation on the rollup option; and
in response to a selection operation and a confirmation operation on a first target child object of the plurality of child objects, rolling up a schedule planning attribute of the first target child object to obtain a rollup result, and associating the rollup result with the schedule planning attribute of the parent object.

18. The non-transitory computer-readable storage medium according to claim 16, wherein the program further implements:
obtaining second schedule planning information of the schedule planning attribute of the parent object;
determining first schedule planning information of the parent object based on the second schedule planning information and the rollup result; and
presenting the first schedule planning information in the schedule planning attribute presenting area of the details page.

19. The non-transitory computer-readable storage medium according to claim 18, wherein determining the first schedule planning information of the parent object based on the second schedule planning information and the rollup result comprises:
determining the first schedule planning information of the parent object based on a range indicated by the second schedule planning information and a range indicated by the rollup result, the range indicated by the first schedule planning information being greater than or equal to the range indicated by the rollup result.

20. The non-transitory computer-readable storage medium according to claim 15, wherein the program further implements:
presenting a configuration page, the configuration page being used to configure an attribute of the parent object, the attribute of the parent object comprising a status switch condition, the configuration page comprising a status switch condition configuration item;
presenting a plurality of child objects in response to a trigger operation on the status switch condition configuration item; and
in response to a selection operation and a confirmation operation on a second target child object of the plurality of child objects, setting the status switch condition for the parent object based on the second target child object, the status switch condition being used to determine whether a status of the parent object is allowed to be switched to a complete status, and the status switch condition comprising that the second target child object is in the complete status.
